(19) United States
(12) Patent Application Publication
(10) Pub. No.: US 2013/0069847 A1
(43) Pub. Date: Mar. 21, 2013

(54) ANTENNA STRUCTURE USED TO SEPARATE HOT SPOTS FOR DECREASING THE SAR VALUE

(71) Applicant: CHI-MING CHIANG, TAOYUAN COUNTY (TW)

(72) Inventor: CHI-MING CHIANG, TAOYUAN COUNTY (TW)

(73) Assignee: AUDEN TECHNO CORP., TAOYUAN COUNTY (TW)

(21) Appl. No.: 13/238,203

(22) Filed: Sep. 21, 2011

(51) Int. Cl. H01Q 21/00

(52) U.S. Cl. 343/893

(57) ABSTRACT

An antenna structure used to separate hot spots for decreasing the SAR value includes a substrate unit, a microstrip line unit, a grounding unit, a first radiation unit, and a second radiation unit. The substrate unit includes a substrate body having a first surface and a second surface. The microstrip line unit includes a microstrip line disposed on the first surface of the substrate body and the microstrip line has a first end and a second end. The grounding unit includes a grounding line disposed on the second surface of the substrate body. The first radiation unit includes a first radiation line disposed on the first surface of the substrate body and extended from the first end of the microstrip line. The second radiation unit includes a second radiation line disposed on the first surface of the substrate body and extended from the second end of the microstrip line.

### BACKGROUND OF THE INVENTION

1. Field of the Invention

The instant disclosure relates to an antenna structure, and more particularly, to an antenna structure used to separate hot spots for decreasing the SAR value.

2. Description of Related Art

As the development of modern mobile communication industry, mobile phone becomes popular. However, the electromagnetic wave sent from the mobile phones might be harmful to the health of the user. The user of the mobile phone must make the head approached to the mobile phone. At the same time, the electromagnetic wave goes through the head. Consequently, part of the electromagnetic wave is absorbed by the body and further changed into heat energy which might be harmful to the user. Therefore, modern mobile phones are required to lower the SAR (Specific Absorption Rate) which is the measurement for determining the amount of RF energy absorbed by the body when using a mobile phone. It is benefit for user's healthy.

### SUMMARY OF THE INVENTION

One aspect of the instant disclosure relates to an antenna structure used to separate hot spots for decreasing the SAR value.

One of the embodiments of the instant disclosure provides an antenna structure used to separate hot spots for decreasing the SAR value, comprising: a substrate unit, a microstrip line unit, a grounding unit, a first radiation unit, and a second radiation unit. The substrate unit includes at least one substrate body, wherein the at least one substrate body has a first surface and a second surface, and the first surface and the second surface are two opposite surface of the at least one substrate body. The microstrip line unit includes at least one microstrip line disposed on the first surface of the at least one substrate body, wherein the at least one microstrip line has a first end and a second end, and the first end and the second end are two opposite ends of the at least one microstrip line. The grounding unit includes at least one grounding line disposed on the second surface of the at least one substrate body and corresponding to the at least one microstrip line, wherein the at least one grounding line has a width larger than that of the at least one microstrip line. The first radiation unit includes at least one first radiation line disposed on the first surface of the at least one substrate body and extended from the first end of the at least one microstrip line. The second radiation unit includes at least one second radiation line disposed on the first surface of the at least one substrate body and extended from the second end of the at least one microstrip line.

Therefore, because the at least one microstrip line is disposed on the first surface of the at least one substrate body and the at least one grounding line is disposed on the second surface of the at least one substrate body and corresponding to the at least one microstrip line, the hot spots can be separated and distributed between the first radiation unit and the second radiation unit to reduce the SAR value of the antenna structure by matching the microstrip line and the grounding line.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1A shows a front, schematic view of the antenna structure according to the first embodiment of the instant disclosure;

FIG. 1B shows a back, schematic view of the antenna structure according to the first embodiment of the instant disclosure;

FIG. 2A shows a front, schematic view of the antenna structure according to the second embodiment of the instant disclosure;

FIG. 2B shows a back, schematic view of the antenna structure according to the second embodiment of the instant disclosure;

FIG. 2C shows a graph illustrating results of measuring an actual VSWR of the antenna structure according to the second embodiment of the instant disclosure; and

FIG. 3 shows a lateral, schematic view of the antenna structure according to the third embodiment of the instant disclosure.

### DETAILED DESCRIPTION OF THE PREFERRED EMBODIMENTS

### First Embodiment

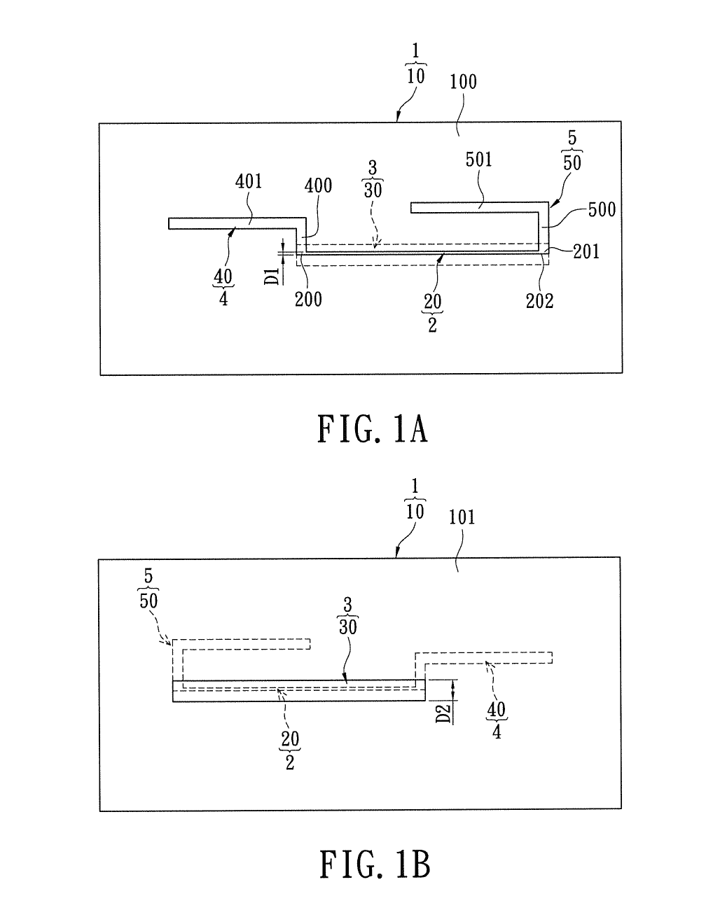

Referring to FIGS. 1A and 1B, where the first embodiment provides an antenna structure used to separate hot spots for decreasing the SAR value, comprising: a substrate unit 1, a microstrip line unit 2, a grounding unit 3, a first radiation unit 4, and a second radiation unit 5. In addition, the microstrip line 2, the first radiation line 4, and the second radiation line 5 can be integrated with each other to form a one piece.

Furthermore, the substrate unit 1 includes at least one substrate body 10. The substrate body 10 has a first surface 100 and a second surface 101, and the first surface 100 and the second surface 101 may be two opposite surface of the substrate body 10. For example, the substrate body 10 may be a microwave substrate. However, the substrate body 10 used in the instant disclosure is merely an example and is not meant to limit the instant disclosure.

Moreover, the microstrip line unit 2 includes at least one microstrip line 20 disposed on the first surface 100 of the substrate body 10. In addition, the microstrip line 20 has a first end 200 and a second end 201, and the first end 200 and the second end 201 may be two opposite ends of the microstrip line 20. For example, the microstrip line 20 has a signal feeding point 202 adjacent to the second radiation unit 5, thus the instant disclosure can use a probe (such as a pogo pin) to touch the signal feeding point 202 for receiving antenna signals.

Besides, the grounding unit 3 includes at least one grounding line 30 disposed on the second surface 101 of the substrate body 10 and corresponding to the microstrip line 20, and the grounding line 30 is certainly larger than the microstrip line 20. For example, the grounding line 30 has a width D2 larger than the width D1 of the microstrip line 20, and the area of the top surface of the grounding line 30 is larger than the area of the top surface of the microstrip line 20. In addition, the instant disclosure can obtain a predetermined impedance matching by adjusting the width D1 of the microstrip line 20, such as the best impedance matching may be 50Ω. However, the best impedance matching is merely an example and is not meant to limit the instant disclosure.

Furthermore, the first radiation unit 4 includes at least one first radiation line 40 disposed on the first surface 100 of the substrate body 10 and extended from the first end 200 of the microstrip line 20. The second radiation unit 5 includes at least one second radiation line 50 disposed on the first surface 100 of the substrate body 10 and extended from the second end 201 of the microstrip line 20.

For example, the first radiation line 40 has a first extending portion 400 extended vertically from the first end 200 of the microstrip line 20 and a second extending portion 401 extended vertically from one end of the first extending portion 400 and far away from the second radiation line 50. However, the first radiation line 40 used in the instant disclosure is merely an example and is not meant to limit the instant disclosure. In addition, the second radiation line 50 has a first extending portion 500 extended vertically from the second end 201 of the microstrip line 20 and a second extending portion 501 extended vertically from one end of the first extending portion 500 and toward the first radiation line 40. However, the second radiation line 50 used in the instant disclosure is merely an example and is not meant to limit the instant disclosure.

Therefore, the microstrip line 20 and the grounding line 30 can be matched with each other to obtain a predetermined impedance matching between the first radiation unit 4 and the second radiation unit 5, thus the hot spots generated by the antenna structure of the instant disclosure can be distributed between the first radiation unit 4 and the second radiation unit 5. In other words, because the hot spots can be separated and distributed between the first radiation unit 4 and the second radiation unit 5 by matching the microstrip line 20 and the grounding line 30, the SAR value of the antenna structure can be reduced effectively. For example, the antenna structure of the first embodiment is tested to obtain the SAR value about 0.953809 mW/g.

### Second Embodiment

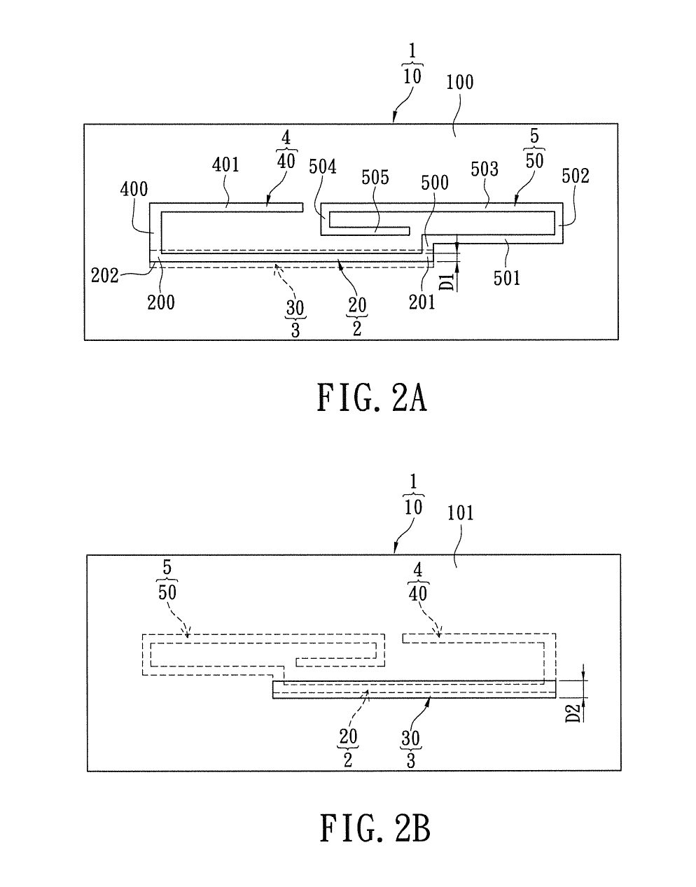

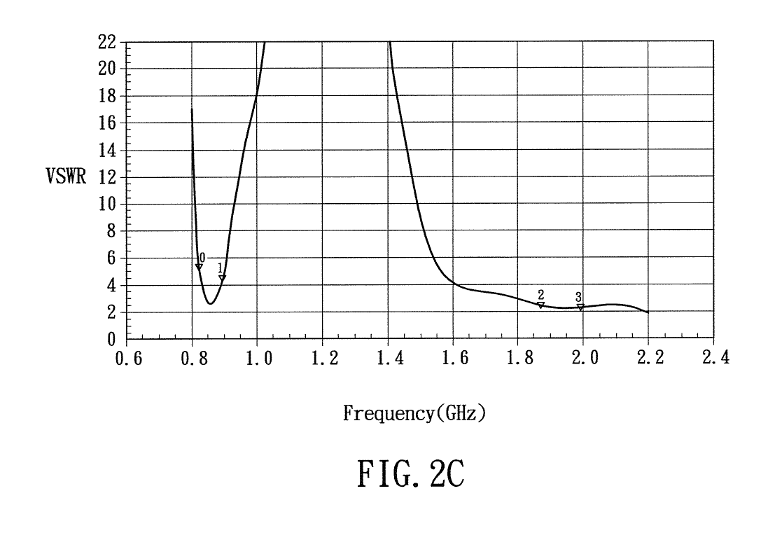

Referring to FIGS. 2A and 2B, where the second embodiment provides an antenna structure used to separate hot spots for decreasing the SAR value, comprising: a substrate unit 1, a microstrip line unit 2, a grounding unit 3, a first radiation unit 4, and a second radiation unit 5. In addition, the microstrip line 2, the first radiation line 4, and the second radiation line 5 can be integrated with each other to form a one piece.

Furthermore, the substrate unit 1 includes at least one substrate body 10. The substrate body 10 has a first surface 100 and a second surface 101, and the first surface 100 and the second surface 101 may be two opposite surface of the substrate body 10. For example, the substrate body 10 may be a microwave substrate. However, the substrate body 10 used in the instant disclosure is merely an example and is not meant to limit the instant disclosure.

Moreover, the microstrip line unit 2 includes at least one microstrip line 20 disposed on the first surface 100 of the substrate body 10. In addition, the microstrip line 20 has a first end 200 and a second end 201, and the first end 200 and the second end 201 may be two opposite ends of the microstrip line 20. For example, the microstrip line 20 has a signal feeding point 202 adjacent to the first radiation unit 4, thus the instant disclosure can use a probe (such as a pogo pin) to touch the signal feeding point 202 for receiving antenna signals.

Besides, the grounding unit 3 includes at least one grounding line 30 disposed on the second surface 101 of the substrate body 10 and corresponding to the microstrip line 20, and the grounding line 30 is certainly larger than the microstrip line 20. For example, the grounding line 30 has a width D2 larger than the width D1 of the microstrip line 20, and the area of the top surface of the grounding line 30 is larger than the area of the top surface of the microstrip line 20. In addition, the instant disclosure can obtain a predetermined impedance matching by adjusting the width D1 of the microstrip line 20, such as the best impedance matching may be 50Ω. However, the best impedance matching is merely an example and is not meant to limit the instant disclosure.

Furthermore, the first radiation unit 4 includes at least one first radiation line 40 disposed on the first surface 100 of the substrate body 10 and extended from the first end 200 of the microstrip line 20. The second radiation unit 5 includes at least one second radiation line 50 disposed on the first surface 100 of the substrate body 10 and extended from the second end 201 of the microstrip line 20.

For example, the first radiation line 40 has a first extending portion 400 extended vertically from the first end 200 of the microstrip line 20 and a second extending portion 401 extended vertically from one end of the first extending portion 400 and toward the second radiation line 50. However, the first radiation line 40 used in the instant disclosure is merely an example and is not meant to limit the instant disclosure. In addition, the second radiation line 50 has a first extending portion 500 extended vertically from the second end 201 of the microstrip line 20, a second extending portion 501 extended vertically from one end of the first extending portion 500 and far away from the first radiation line 40, a third extending portion 502 extended vertically from one end of the second extending portion 501 and far away from the microstrip line 20, a fourth extending portion 503 extended vertically from one end of the third extending portion 502 and toward the first radiation line 40, a fifth extending portion 504 extended vertically from one end of the fourth extending portion 503 and toward the microstrip line 20, and a sixth extending portion 505 extended vertically from one end of the fifth extending portion 504 and far away from the first radiation line 40. However, the second radiation line 50 used in the instant disclosure is merely an example and is not meant to limit the instant disclosure.

Therefore, the microstrip line 20 and the grounding line 30 can be matched with each other to obtain a predetermined impedance matching between the first radiation unit 4 and the second radiation unit 5, thus the hot spots generated by the antenna structure of the instant disclosure can be distributed between the first radiation unit 4 and the second radiation unit 5. In other words, because the hot spots can be separated and distributed between the first radiation unit 4 and the second radiation unit 5 by matching the microstrip line 20 and the grounding line 30, the SAR value of the antenna structure can be reduced effectively. For example, referring to FIG. 2C, the antenna structure of the second embodiment is tested at 849 GHz antenna operating frequency to obtain the SAR value about 1.22767 mW/g, and the antenna structure of the second embodiment is tested at 1880 GHz antenna operating frequency to obtain the SAR value about 1.4061 mW/g.

### Third Embodiment

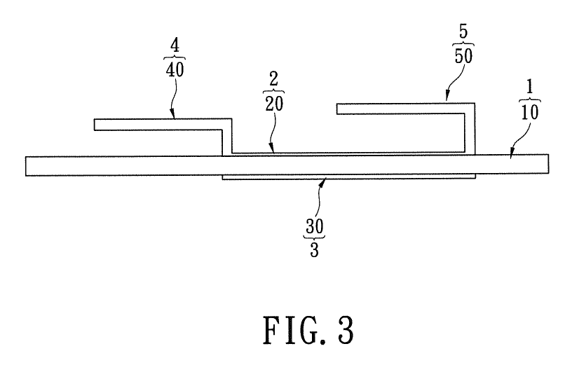

Referring to FIG. 3, where the third embodiment provides an antenna structure used to separate hot spots for decreasing the SAR value, comprising: a substrate unit 1, a microstrip line unit 2, a grounding unit 3, a first radiation unit 4, and a second radiation unit 5. The difference between the third embodiment and the first embodiment is as follows: in the third embodiment, the first radiation line 40 and the second radiation line 50 are respectively extended upwardly from two opposite ends of the microstrip line 20, thus the first radiation line 40 and the second radiation line 50 can be suspended and far away from the substrate body 10.

Of course, the microstrip line 20 and the grounding line 30 can be matched with each other to obtain a predetermined impedance matching between the first radiation unit 4 and the second radiation unit 5, thus the hot spots generated by the antenna structure of the instant disclosure can be distributed between the first radiation unit 4 and the second radiation unit 5. In other words, because the hot spots can be separated and distributed between the first radiation unit 4 and the second radiation unit 5 by matching the microstrip line 20 and the grounding line 30, the SAR value of the antenna structure can be reduced effectively.

In conclusion, because the at least one microstrip line is disposed on the first surface of the at least one substrate body and the at least one grounding line is disposed on the second surface of the at least one substrate body and corresponding to the at least one microstrip line, the hot spots can be separated and distributed between the first radiation unit and the second radiation unit to reduce the SAR value of the antenna structure by matching the microstrip line and the grounding line.

The above-mentioned descriptions merely represent the preferred embodiments of the instant disclosure, without any intention or ability to limit the scope of the instant disclosure which is fully described only within the following claims. Various equivalent changes, alterations or modifications based on the claims of instant disclosure are all, consequently, viewed as being embraced by the scope of the instant disclosure.

What is claimed is:

1. An antenna structure used to separate hot spots for decreasing the SAR value, comprising:
a substrate unit including at least one substrate body, wherein the at least one substrate body has a first surface and a second surface, and the first surface and the second surface are two opposite surface of the at least one substrate body;
a microstrip line unit including at least one microstrip line disposed on the first surface of the at least one substrate body, wherein the at least one microstrip line has a first end and a second end, and the first end and the second end are two opposite ends of the at least one microstrip line;
a grounding unit including at least one grounding line disposed on the second surface of the at least one substrate body and corresponding to the at least one microstrip line, wherein the at least one grounding line has a width larger than that of the at least one microstrip line;
a first radiation unit including at least one first radiation line disposed on the first surface of the at least one substrate body and extended from the first end of the at least one microstrip line; and
a second radiation unit including at least one second radiation line disposed on the first surface of the at least one substrate body and extended from the second end of the at least one microstrip line.

2. The antenna structure of claim 1, wherein the at least one substrate body is a microwave substrate, and the at least one microstrip line, the at least one first radiation line, and the at least one second radiation line are integrated with each other.

3. The antenna structure of claim 1, wherein the at least one microstrip line and the at least one grounding line are matched with each other.

4. The antenna structure of claim 1, wherein the area of the top surface of the at least one grounding line is larger than the area of the top surface of the at least one microstrip line.

5. The antenna structure of claim 1, wherein the at least one microstrip line has a signal feeding point adjacent to the at least one first radiation line.

6. The antenna structure of claim 1, wherein the at least one microstrip line has a signal feeding point adjacent to the at least one second radiation line.

7. The antenna structure of claim 1, wherein the at least one first radiation line has a first extending portion extended vertically from the first end of the at least one microstrip line and a second extending portion extended vertically from one end of the first extending portion and far away from the at least one second radiation line.

8. The antenna structure of claim 1, wherein the at least one second radiation line has a first extending portion extended vertically from the second end of the at least one microstrip line and a second extending portion extended vertically from one end of the first extending portion and toward the at least one first radiation line.

9. The antenna structure of claim 1, wherein the at least one first radiation line has a first extending portion extended vertically from the first end of the at least one microstrip line and a second extending portion extended vertically from one end of the first extending portion and toward the at least one second radiation line.

10. The antenna structure of claim 1, wherein the at least one second radiation line has a first extending portion extended vertically from the second end of the at least one microstrip line, a second extending portion extended vertically from one end of the first extending portion and far away from the at least one first radiation line, a third extending portion extended vertically from one end of the second extending portion and far away from the at least one microstrip line, a fourth extending portion extended vertically from one end of the third extending portion and toward the at least one first radiation line, a fifth extending portion extended vertically from one end of the fourth extending portion and toward the at least one microstrip line, and a sixth extending portion extended vertically from one end of the fifth extending portion and far away from the at least one first radiation line.

11. An antenna structure used to separate hot spots for decreasing the SAR value, comprising:
a substrate unit including at least one substrate body;
a microstrip line unit including at least one microstrip line disposed on one surface of the at least one substrate body;
a grounding unit including at least one grounding line disposed on another surface of the at least one substrate body and corresponding to the at least one microstrip line, wherein the at least one grounding line has a width larger than that of the at least one microstrip line;
a first radiation unit including at least one first radiation line extended from one end of the at least one microstrip line; and
a second radiation unit including at least one second radiation line extended from another end of the at least one microstrip line.

12. The antenna structure of claim 11, wherein the at least one substrate body is a microwave substrate, and the at least one microstrip line, the at least one first radiation line, and the at least one second radiation line are integrated with each other.

13. The antenna structure of claim 11, wherein the at least one microstrip line and the at least one grounding line are matched with each other.

14. The antenna structure of claim 11, wherein the area of the top surface of the at least one grounding line is larger than the area of the top surface of the at least one microstrip line.

15. The antenna structure of claim 11, wherein the at least one microstrip line has a signal feeding point adjacent to the at least one first radiation line.

16. The antenna structure of claim 11, wherein the at least one microstrip line has a signal feeding point adjacent to the at least one second radiation line.

17. The antenna structure of claim 11, wherein the at least one first radiation line has a first extending portion extended vertically from the first end of the at least one microstrip line and a second extending portion extended vertically from one end of the first extending portion and far away from the at least one second radiation line.

18. The antenna structure of claim 11, wherein the at least one second radiation line has a first extending portion extended vertically from the second end of the at least one microstrip line and a second extending portion extended vertically from one end of the first extending portion and toward the at least one first radiation line.

19. The antenna structure of claim 11, wherein the at least one first radiation line has a first extending portion extended vertically from the first end of the at least one microstrip line and a second extending portion extended vertically from one end of the first extending portion and toward the at least one second radiation line.

20. The antenna structure of claim 11, wherein the at least one second radiation line has a first extending portion extended vertically from the second end of the at least one microstrip line, a second extending portion extended vertically from one end of the first extending portion and far away from the at least one first radiation line, a third extending portion extended vertically from one end of the second extending portion and far away from the at least one microstrip line, a fourth extending portion extended vertically from one end of the third extending portion and toward the at least one first radiation line, a fifth extending portion extended vertically from one end of the fourth extending portion and toward the at least one microstrip line, and a sixth extending portion extended vertically from one end of the fifth extending portion and far away from the at least one first radiation line.
